(19) United States
(12) Patent Application Publication
(10) Pub. No.: US 2015/0098775 A1
(43) Pub. Date: Apr. 9, 2015

(54) AUTOMATIC ORDER PICKING SYSTEM AND METHOD IN RETAIL FACILITY

(71) Applicant: Sergey N. RAZUMOV, Moscow (RU)

(72) Inventor: Sergey N. RAZUMOV, Moscow (RU)

(21) Appl. No.: 14/049,552

(22) Filed: Oct. 9, 2013

(51) Int. Cl. B65G 65/00; B66F 11/04; B66F 9/07; B65G 1/02; B65G 1/04

(52) U.S. Cl. CPC B65G 65/005; B65G 1/026; B65G 1/0464; B65G 1/0492; B65G 65/00; B66F 9/07; B66F 11/04; B65G 2203/0283; B65G 2812/09; B65G 2814/0311
USPC 414/282; 414/807

(57) ABSTRACT

An order picking system includes a storage system for storing containers arranged in multiple rows at various horizontal levels with respect to ground, the containers including source containers with goods stored in the storage system and reception containers to be filled with the ordered goods. At least one mobile picking unit may be moved in a horizontal direction along an upper level of the storage system, the picking unit is configured for taking ordered goods from the source containers arranged at the upper level and placing the ordered goods into the reception containers for delivery to the customers. At least one transportation unit may be moved along a lower level of the storage system arranged lower than the upper level. The transportation unit is configured for taking the containers from levels of the storage system lower than the upper level, and delivering the containers to the upper level.

### TECHNICAL FIELD

This disclosure relates to retail logistics, and more particularly, to system and method for order picking in a retail store.

### BACKGROUND ART

Order picking operations involve extracting specified goods from a storage area in a retail facility, and collecting them to prepare a customer's order. Order picking processes have become the most labor-intensive and costly part of the supply chain for any retail environment.

A conventional order picking process involves a storage area that contains goods, and a picking area in which a human picking operator or a picking device extracts the goods delivered from the storage area from different containers to fill an order container to be delivered to a customer. When the order volume is low, a human picking operator may move from one picking location to another to pick up different goods and place them into an empty container. However, such a manual order picking process is slow and involves substantial labor cost when a large number of orders must be processed.

In a conventional order picking system that handles a large number of orders, a stationary picking mechanism may be used to take goods from containers delivered by one conveyor system and place the goods into empty containers delivered by another conveyor system. This picking system can fulfill a large number of customers' orders made in advance. However, while fulfilling orders made in advance, this system cannot quickly respond to urgent orders made by customers who request that their orders be fulfilled immediately. For example, an urgent order may be made by a customer who is shopping in a retail facility and cannot find a required item on the shelf, or by a customer who needs to order an item in addition to an order made in advance.

Moreover, the conveyor systems used for delivery the ordered goods and empty containers require complex logistics and is subject to frequent malfunctions.

In addition, the conventional systems involve separate storage and picking areas and conveyor systems arranged between them. As a result, a large area in a retail facility is required to perform order picking operations.

Therefore, it would be desirable to develop a novel automatic order picking system capable of operating in a compact retail facility, and able to quickly fulfill urgent customers' orders while performing order picking operations for orders made in advance.

### SUMMARY OF THE DISCLOSURE

In accordance with one aspect, the present disclosure offers an order picking system responsive to customers' orders for picking ordered goods. The order picking system includes a storage system for storing containers arranged in multiple rows at various horizontal levels with respect to ground, the containers including source containers with goods stored in the storage system and reception containers to be filled with the ordered goods.

At least one mobile picking unit may be moved in a horizontal direction along an upper level of the storage system, the picking unit is configured for taking ordered goods from the source containers arranged at the upper level and placing the ordered goods into the reception containers for delivery to the customers.

At least one transportation unit may be moved along a lower level of the storage system arranged lower than the upper level. The transportation unit is configured for taking the containers from levels of the storage system lower than the upper level, and delivering the containers to the upper level.

The storage system may include first and second storage sections, and the picking unit and the transportation unit may be configured for moving in the horizontal direction in a passage between the first storage section and the second storage section so as to have access to the containers arranged in both the first and the second storage sections.

For example, the picking unit and the transportation unit may move along upper and lower rails arranged corresponding to the upper and lower levels, respectively.

In an exemplary embodiment, the transportation unit may include a frame movable along the lower rails and a movable platform configured to move down with respect to the frame to take a container arranged at levels below a level corresponding to the lower rails.

The movable platform may be further configured to move up with respect to the frame after taking the container, so as to carry the taken container to the upper level.

Also, the movable platform may be configured to move up with respect to the frame to take the containers arranged at levels above a level corresponding to the lower rails but below a level corresponding to the upper rails, and then, to move up again so as to carry the taken container to the upper level.

In an exemplary embodiment, the picking unit may includes a manipulator with an article holder for holding an article, a protection case with an opening in a bottom portion, and a gate controlled between an open state, in which the article holder is allowed to pass through the opening, and a close state, in which the opening is closed to prevent the article from falling from the protection case when the article is carried by the article holder from a source container to a reception container.

The picking unit may be configured for taking the reception container and carrying the reception container along the upper level when the picking unit moves from one source container to another source container.

Also, frequently ordered goods may be stored in source containers arranged at the upper level so as to reduce an order picking time.

In accordance with a method of the present disclosure, order picking operations are performed in a storage system for storing containers arranged in multiple rows at various horizontal levels with respect to ground, using at least one mobile picking unit movable in a horizontal direction along an upper level of the storage system and at least one transportation unit movable along a lower level of the storage system arranged lower than the upper level. The method comprises the steps of:
controlling the transportation unit to take a first container from a level below the upper level and carry the first container to the upper level, and
controlling the picking unit to pick up an ordered article from the first container delivered by the transportation unit to the upper level, and place the article into a second container.

The method may further comprise the step of controlling the transportation unit to take the second container and carry the second container to a level below the upper level for delivery to a customer.

In an exemplary embodiment, the method may further comprise the steps of:
controlling the transportation unit having a movable platform to move along the lower level to a selected position corresponding to a position of the first container at a first level below or above the lower level,
controlling the movable platform to move in a vertical direction to the first level to load the first container to the movable platform, and
controlling the movable platform to move in the vertical direction to the upper level to unload the first container at the upper level.

In an exemplary embodiment, the picking unit may have a protection case and a gate configured to provide an opening in a bottom portion of the protection case when the gate is in an open state, and to close the opening when the gate is in a closed state. The method may comprise the steps of:
placing the gate into the open state to take an article from the first container via the opening in the protection case using an article holder,
placing the gate into the closed state when the article holder raises the article above the bottom portion of the protection case,
moving the article holder with the article from a position above the first container to a position above the second container when the gate is in the closed state,
simultaneously with moving the article holder, moving the protection case from the position above the first container to the position above the second container so as to maintain the article above the bottom portion of the protection case, and
switching the gate into the open state to place the article to the second container via the opening in the protection case. The second container may be carried by the picking unit.

Additional advantages and aspects of the disclosure will become readily apparent to those skilled in the art from the following detailed description, wherein embodiments of the present disclosure are shown and described, simply by way of illustration of the best mode contemplated for practicing the present disclosure. As will be described, the disclosure is capable of other and different embodiments, and its several details are susceptible of modification in various obvious respects, all without departing from the spirit of the disclosure. Accordingly, the drawings and description are to be regarded as illustrative in nature, and not as limitative.

### BRIEF DESCRIPTION OF THE DRAWINGS

The following detailed description of the embodiments of the present disclosure can best be understood when read in conjunction with the following drawings, in which the features are not necessarily drawn to scale but rather are drawn as to best illustrate the pertinent features, wherein:

FIG. 1 shows an exemplary embodiment of an automatic order picking system of the present disclosure.

FIG. 2 illustrates an exemplary control system for controlling operations of the order picking system.

FIG. 3 shows an exemplary embodiment of a mobile transportation unit in accordance with the present disclosure.

FIG. 4 illustrates elements for supporting operations of the mobile transportation unit.

FIG. 5 shows an exemplary embodiment of the picking unit in accordance with the present disclosure.

FIG. 6 illustrates elements for supporting operations of the picking unit.

FIG. 7 illustrates exemplary operations of the mobile transportation unit.

FIGS. 8-13 illustrate exemplary operations of the picking unit.

### DETAILED DISCLOSURE OF THE EMBODIMENTS

The present disclosure will be made using specific examples of an order picking system in a retail facility. It will become apparent, however, that the concept of the disclosure is applicable to any system for processing orders in a retail facility or warehouse.

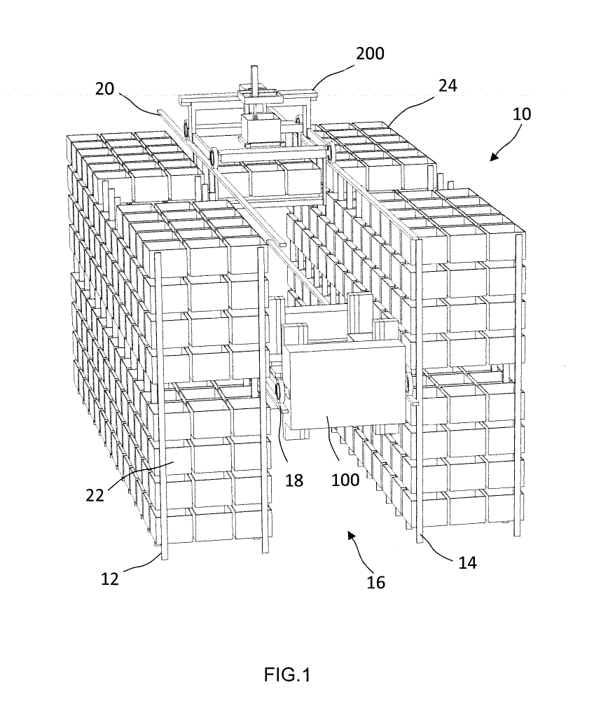

FIG. 1 illustrates an exemplary embodiment of an automatic order picking system 10 in accordance with the present disclosure. The order picking system 10 includes a storage area formed by storage racks 12 and 14, each of which includes shelves for arranging containers in multiple rows at various horizontal levels with respect to the ground. The containers may be any objects capable of holding goods stored in the storage area, such as cartons, boxes, crates, or pallets.

As shown in FIG. 1, the shelf at each level of the storage area may contain multiple containers. The storage racks 12 and 14 may be arranged so as to provide a passage 16 between them. For example, the storage racks 12 and 14 may be arranged in a retail facility for selling goods. Also, the storage racks 12 and 14 may form an automated self-service retail kiosk for fulfilling customers' orders based on the stored goods.

At least one mobile transportation unit 100 may be provided in the passage 16 for accessing containers at one level of the storage area and carrying them to another level. Also, at least one picking unit 200 may be provided in the passage 16 for providing order picking operations at a selected level of the storage area. The mobile transportation unit 100 may be configured for moving along rails 18 arranged in a horizontal direction on both sides of the passage 16. The picking unit 200 may be configured for moving along rails 20 also arranged in a horizontal direction from both sides of the passage 16. The rails 18 may be arranged at a lower level than the rails 20 so as to allow the transportation unit 100 to operate without interfering with the operation of the picking unit 200.

In an exemplary embodiment, the rails 20 are arranged corresponding to the top level of the storage area so as to enable the picking unit 200 to perform order picking operations with goods stored in the containers arranged on the top level of the storage area. Hence, in the exemplary embodiment, a picking area of the automatic order picking system 10 is provided at the top level of the storage area. Such an arrangement would provide sufficient space for operations of the picking unit 200 that may require vertical movements of a picking element with respect to containers. The transportation unit 100 is configured for taking containers from any level of the storage area below the picking area level, and carrying the containers to the picking area level using a lifting mechanism discussed below. Also, the transportation unit 100 may take containers arranged at the picking area level and move them to any level below the picking area level.

Containers arranged in the storage racks 12 and 14 include “source” containers 22 used for keeping goods in the storage area, and “reception” containers 24 used for receiving goods extracted from the source containers 22 to prepare a customer's order. The source and reception containers may be arranged at any level of the storage area including the picking area level. The transportation unit 100 delivers source containers and empty reception containers from any level below the picking area level to the picking area level, at which the picking unit 200 extracts ordered goods from the source containers and place them into the reception containers. The source containers 22 with remaining goods and the reception containers 24 with fulfilled customers' orders may be taken by the transportation unit 100 from the picking area level for delivery to any selected level below the picking area level. Loading ports for loading containers with goods and empty containers into the storage area, and delivery ports for delivery of reception containers outside of the storage area may be provided at any level of the storage area.

Hence, operations of the automatic picking system 10 involve at least two stages. At the first stage, source and/or reception containers are delivered from a lower level of the storage area to an upper level of the storage area. At the second stage, ordered goods are extracted from the source containers arranged at the upper level and are placed into a reception container.

To increase efficiency of the order picking system 10, source containers 22 with goods which are ordered more frequently may be kept at the picking area level so as to save time required to deliver them from a lower level. Also, a predetermined number of empty reception containers 24 may be kept at the picking area level to avoid their delivery for each order.

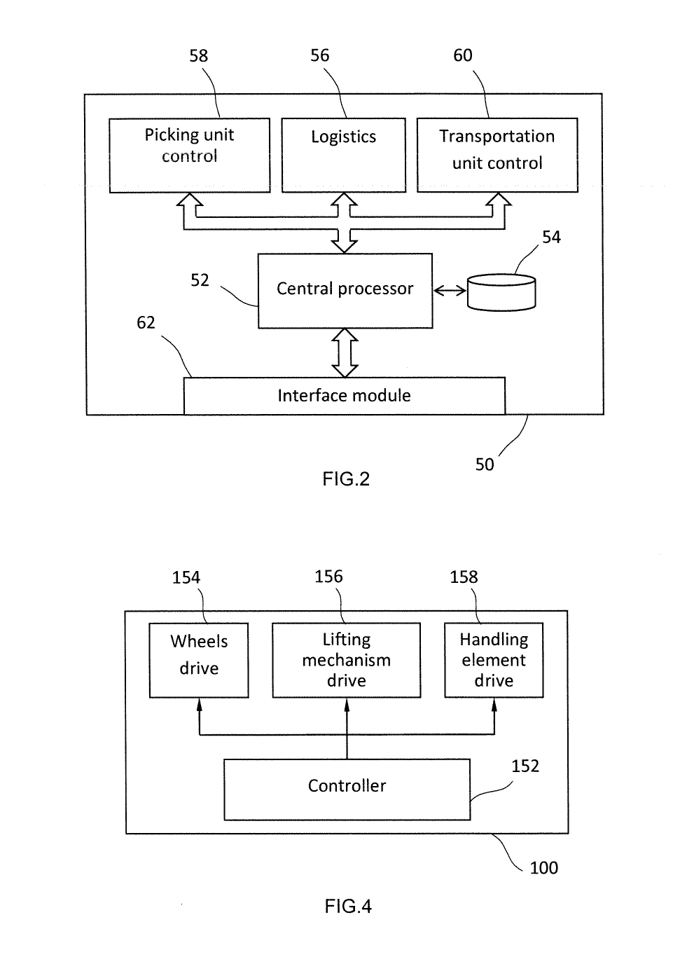

FIG. 2 illustrates a simplified diagram of an exemplary control unit 50 provided in the automatic order picking system 10 for controlling its operations. The control unit 50 may include a central processor 52 operating with a memory 54. The central processor 52 may be a data processor responsive to external commands for processing the commands and producing various control signals. The processor 52 may interacts with a logistics module 56, a picking unit control module 58, a transportation unit control module 60, and an interface module 62. In response to customers' orders, the control unit 50 generates tasks for the transportation unit 100 and the picking unit 200. The tasks may be generated based on a received customer's order, the position and/or the state of the transportation unit 100 and the picking unit 200 and other considerations.

The logistics module 56 performs logistics operations in connection with arranging source and reception containers in the storage area in an efficient manner, and moving source and reception containers within the storage area to fulfill specific customers' orders. The picking unit control module 58 controls operations of the picking unit 200. The transportation unit control module 60 controls operations of the transportation unit 100. The interface module 62 supports communications between the control unit 50 and the other components of the order picking system 10.

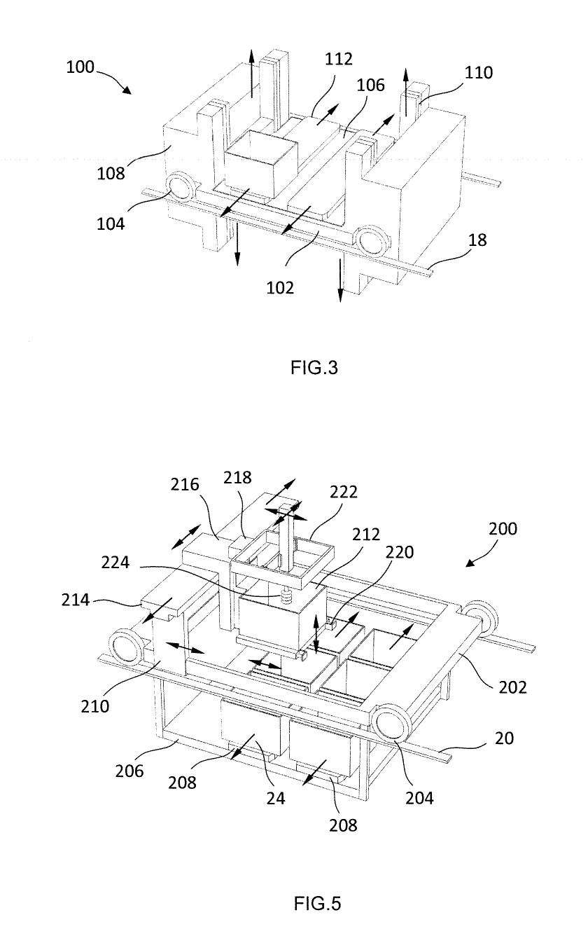

FIG. 3 illustrates an exemplary embodiment of the mobile transportation unit 100 that may include a frame 102 with four wheels 104 fixed to the frame 102 which may be formed as a braced structure for supporting elements required to operate the transportation unit 100. Each wheel 104 may be attached to the frame 102 so as to rotate in a vertical plane about an axis extending from the center of the wheel 104 in order to move the transportation unit 100 along the rails 18.

The frame 102 may hold a movable platform 106 that can be used for carrying containers. For example, the platform 106 may be a rectangular metal plate configured to accommodate containers. Side walls 108 may be provided on the frame 102 to support loading and carrying containers.

As discussed in more detail below, the platform 106 may move in a vertical direction up and down with respect to the frame 102 so as to access containers arranged at levels above and below the level at which the rails 18 are arranged. A platform lifting mechanism 110 may be arranged at the side walls 108 to move the platform 106 in a vertical direction.

One or more handling elements 112 may be mounted on the platform 106 and configured for operating with containers. The handling element 112 may take one or more containers from the storage rack at one level of the storage area, place the container onto the transportation unit 100 for carrying to another level, and remove the container from the transportation unit 100 for placing it at a selected level. The handling element 112 may be extended in a horizontal direction from any or both sides of the transportation unit 100 so as to handle containers arranged at any or both storage racks 12 and 14. For example, the handling element 112 may be implemented as a metal plate, spade, fork or pulling device.

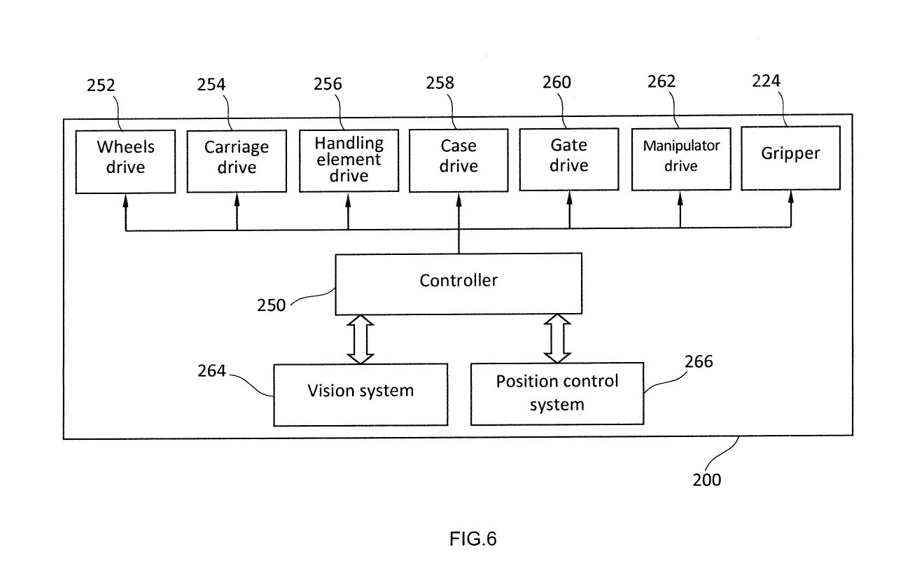

FIG. 4 is a simplified block diagram that illustrates elements for supporting various operations performed by the transportation unit 100. The operations of the transportation unit 100 are controlled by a controller 152 that may include a data processor responsive to external commands for processing the commands and producing various control signals. The controller 152 may communicate with various elements of the transportation unit 100 to supply control signals to the elements of the transportation unit 100 and receive responses.

In particular, the controller 152 may control a wheels drive 154, a platform lifting mechanism drive 156 and a handling element drive 158. The wheels drive 154 and the platform lifting mechanism drive 156 may be arranged on the frame 102, whereas the handling element drive 158 may be arranged on the movable platform 106.

The wheels drive 154 is provided for driving the wheels 104 so as to rotate them in a vertical plane in order to move the transportation unit 100 along the rails 18 in a horizontal direction. The wheels drive 154 may be implemented using any of well known mechanisms for rotating wheels.

The platform lifting mechanism drive 156 is provided for driving the platform lifting mechanism 110 that move the platform 106 up and down in a vertical direction. The platform lifting mechanism 110 and drive 156 may be implemented using any well known mechanisms for moving a plate up and down. For example, telescopic mechanisms can be utilized.

The handling element drive 158 is provided for extending the handling element 112 from a desired side of the transportation unit 100 so as to enable the handling element 112 to operate with a container. For example, the handling element drive 158 may be implemented using a telescopic linear actuator.

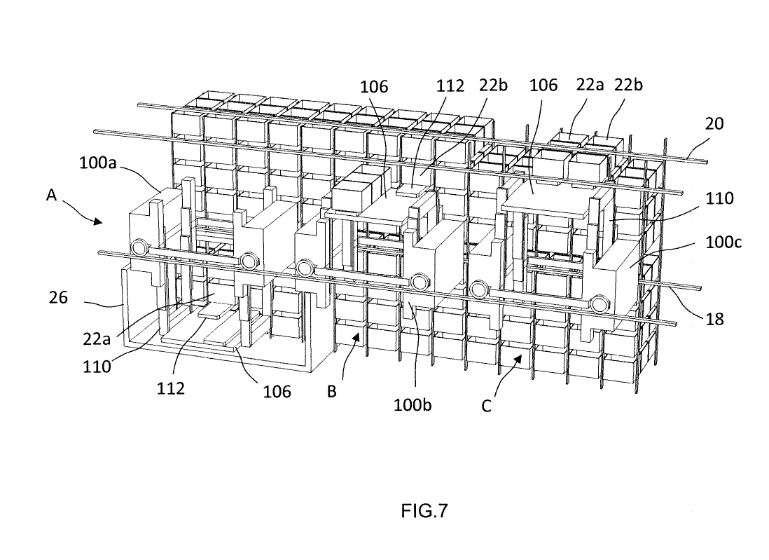

FIG. 5 illustrates an exemplary embodiment of the picking unit 200 that may include a frame 202 with four wheels 204 fixed to the frame 202 which may be formed as a braced structure for supporting elements required to operate the picking unit 200. Each wheel 204 may be attached to the frame 202 so as to rotate in a vertical plane about an axis extending from the center of the wheel 204 in order to move the picking unit 200 along the rails 20.

The frame 202 may hold a platform 206 that can be used for carrying containers. The platform 206 may be a rectangular metal plate configured to accommodate containers. For example, the reception containers 24 may be carried on the platform 206.

One or more handling elements 208 may be mounted on the platform 106 and configured for operating with containers. The handling element 208 may take one or more containers from the storage rack and place the container onto the picking unit 200 for carrying it along the picking area level. Further, the handling element 208 may remove the container from the picking unit 200 for placing it at a selected location. For example, FIG. 5 shows two handling elements 208 carrying reception containers 24 placed on the platform 206.

The handling element 208 may be extended in a horizontal direction from any or both sides of the picking unit 200 so as to handle containers arranged at any or both storage racks 12 and 14. For example, the handling element 208 may be implemented as a metal plate, spade, pulling device or fork.

A carriage 210 is mounted on the frame 202 for moving a protection case 212 during order picking operations. As discussed in more detail below, the protection case 212 is used for protecting goods picked from a source container from falling down before they are transferred to a reception container. The carriage 210 is movable with respect to the frame 202 to provide movement of the protective case 212 with respect to the handling element 208. The carriage 210 may be implemented as a portal-shaped element having vertical members arranged on both sides of the frame 202 and a horizontal member between the vertical members.

A movable traverse element 214 may be mounted on the horizontal member of the carriage 210 to carry a horizontal movement carriage 216. A vertical movement carriage 218 is fixed to the horizontal movement carriage 216. The movable traverse element 214 together with the horizontal movement carriage 216 and the vertical movement carriage 218 are used to move the protection case 212 with respect to the frame 202. The movable traverse element 214 is movable in a side direction with respect to the frame 202 to extend beyond both horizontal members of the portal-shaped carriage 210.

The bottom surface of the protection case 212 includes a gate 220 which has an open state to provide opening in the bottom portion of the protection case 212. For example, the opening may be provided at the bottom surface of the protection case 212. Also, the gate 220 has a closed state in which the opening in the bottom portion of the protection case 212 is closed. For example, the gate 220 may be implemented as a sliding door that moves along the bottom surface of the protection case 212 between the open and closed positions.

The vertical movement carriage 218 carries a manipulator 222 with a gripper 224 configured to take a product from a source container and hold the product until it is placed into a reception container. For example, the gripper 224 may include one or more suction caps that use negative fluid pressure of air to adhere to a surface of a product in the source container. Other devices, such as brushes or pneumatic fingers may be used instead of suction caps. Conventional vacuum pumps, vacuum blowers, or ejectors (not shown) may be used for creating air pressure required for operation of the suction cups. For example, a vacuum pump may be arranged on the frame 202, and vacuum blowers and ejectors may be fixed to the manipulator 222.

The manipulator 222 may be configured to enable the gripper 224 to move along three mutually perpendicular directions. The manipulator 222 may operate as three linear actuators for providing movements along three mutually perpendicular directions. For example, it may be implemented by a delta robot or the other type of robotic manipulator.

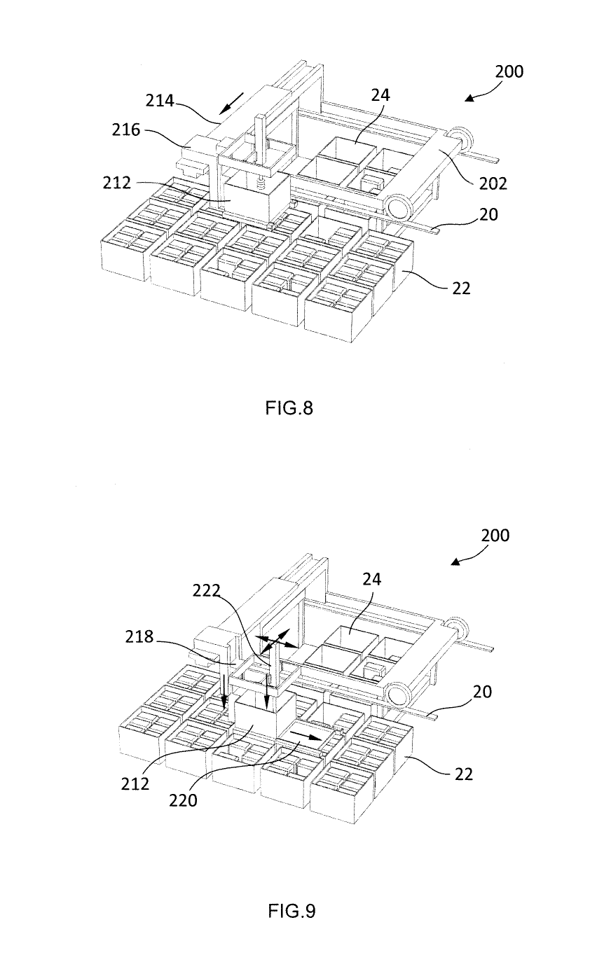

FIG. 6 is a simplified block diagram that illustrates elements for supporting various operations performed by the picking unit 200. The operations of the picking unit 200 are controlled by a controller 250 that may include a data processor responsive to external commands for processing the commands and producing various control signals. The controller 250 may communicate with various elements of the picking unit 200 to supply control signals to the elements of the transportation unit 100 and receive responses.

In particular, the controller 250 may control a wheels drive 252, a carriage drive 254, a handling element drive 256, a case drive 260, a manipulator drive 262 and the gripper 224. Also, the controller 250 may interact with a vision system 264 and a position control system 266.

The wheels drive 252 is provided for driving the wheels 204 so as to rotate them in a vertical plane in order to move the picking unit 200 along the rails 20 in a horizontal direction. The wheels drive 252 may be implemented using any of well known mechanisms for rotating wheels.

The carriage drive 254 is configured for moving the portal-shaped carriage 210 in a horizontal direction with respect to the frame 202. For example, a linear actuator, such as a conventional chain or belt drive may be used as the carriage drive 254.

The handling element drive 256 is used for extending the handling elements 208 from any or both sides of the picking unit 200 so as to enable each handling element 208 to operate with a container. For example, the handling element drive 256 may be implemented using a telescopic linear actuator.

The case drive 258 is configured for transfer the protection case 212 in vertical and horizontal directions during order picking operations. To move the protection case 212, the case drive 258 provides horizontal movements of the traverse element 214 and the carriage 216, and vertical movements of the carriage 218. The case drive 258 may be implemented using well known linear actuators.

The gate drive 260 is used for switching the gate 220 between its open and closed positions, for example, for opening and closing a sliding door. A linear actuator, such as a pneumatic cylinder, may be used as the gate drive 260.

The manipulator drive 262 provides accurate positioning and movements of the manipulator 222 with the gripper 224. For example, the manipulator drive 262 may be implemented using three linear actuators for providing movements of the manipulator 222 along three mutually perpendicular directions.

The vision system 264 including one or more video cameras may be fixed at the manipulator 222 to identify a product to be picked up from the source container 12. Also, the position control system 266, such as a position sensor, may be fixed at the manipulator 222 to monitor position of a product held by the gripper 224. One or more scanners may be used for screening the surface of the container before placing a new item.

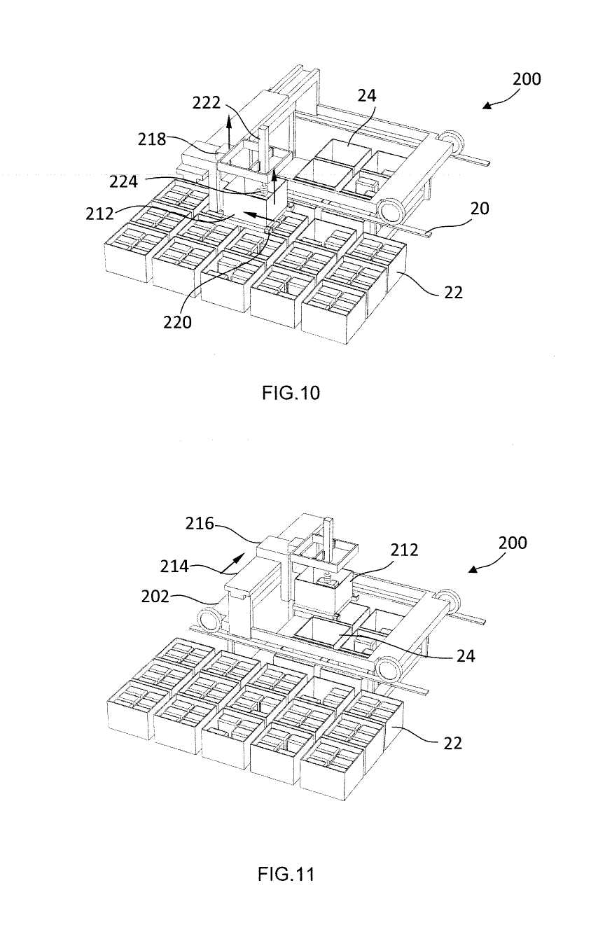

FIG. 7 illustrates exemplary operation of the transportation unit 100. This drawing illustrates three exemplary positions 100a, 100b and 100c occupied by the transportation unit 100 in the order picking system 10. To make the illustration more clear, when the transportation unit 100 is in the position corresponding to section A of the storage rack, FIG. 7 shows it as a transportation unit 100a, when the transportation unit 100 is in the position corresponding to section B of the storage rack, FIG. 7 shows it as a transportation unit 100b, and when the transportation unit 100 is in the position corresponding to section C of the storage rack, FIG. 7 shows it as a transportation unit 100c. Also, for clarity, the picking unit 200 is not shown in FIG. 7. In the illustrated example, the transportation unit 100 may include two handling elements 112 extending from the opposite sides of the transportation unit 100.

In response to customers' orders, the transportation unit 100 may locate source containers 22 that store the goods ordered by customers, to deliver the located containers 22 to the storage level corresponding to the picking area. For example, customer's order may include goods stored in containers 22a in the storage section A, which includes a refrigerating section 26, and goods stored in containers 22b in the storage section B.

To access the source containers 22a, the transportation unit 100 may be moved along the rails 18 into the position 100a to access source containers 22a stored in the storage section A. As the source containers 22a are arranged at the storage level below the level at which the transportation unit 100 moves along the rails 18, the platform lifting mechanism 110 moves the movable platform 106 down to the level of the storage rack at which a required source container 22a is maintained. The wheels 104 are controlled to accurately position the transportation unit 100 so as to place one of the handling elements 112 across the required container 22a. The handling element 112 is extended from the transportation unit 100 to take the source container 22a and place it onto the platform 106. Then, the platform with the loaded container 22a is moved up to a level corresponding to the level of the storage rack at which the frame 102 of the transportation unit is arranged.

Thereafter, the transportation unit 100 carrying the source container 22a may be moved along the rails 18 into position 100b to access source containers 22b in the storage section B. As the source containers 22b are arranged at the storage level above the level at which the transportation unit 100 moves along the rails 18, the movable platform 106 is moved up to the storage level at which the required source container 22b is positioned. The wheels 104 are controlled to accurately position the second handling element 112 across the required source container 22b. The handling element 112 is activated to take the source container 22b and place it onto the platform 106, which are moved down to the level of the frame 102.

Then, the transportation unit 100 carrying the source containers 22a and 22c are moved along the rails 18 into position 100c to place the source containers 22a and 22c at a selected position of the picking area, which may be provided at the top level of the storage area. The platform 106 is moved up to the top level. The wheels 104 are controlled to accurately position the platform 106 across the selected position. Both handling elements 112 are activated to move the containers 22a and 22b from the platform 106 to the selected position of the picking area.

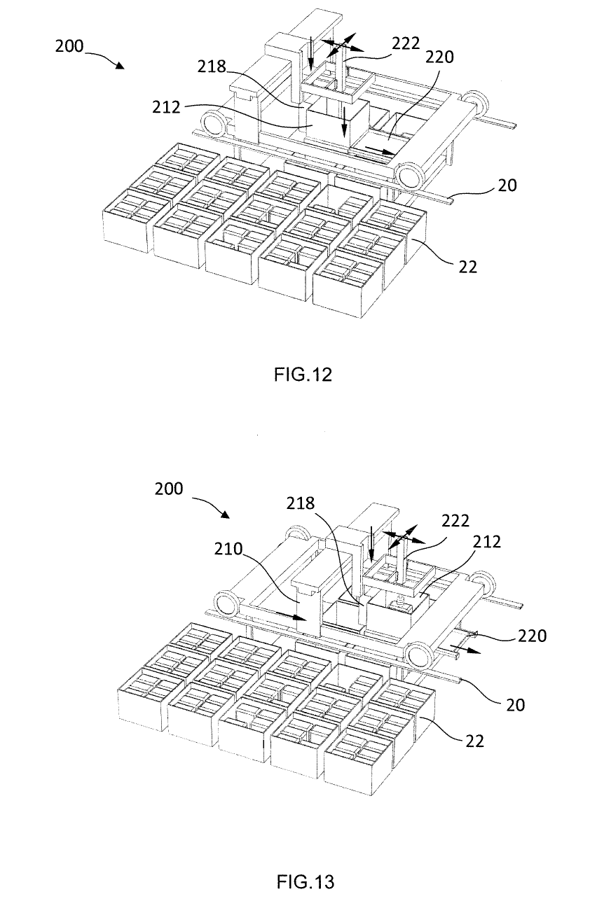

FIGS. 8-13 illustrate exemplary operations of the picking unit 200 which may perform picking operations to fulfill multiple customers' orders at the same time or to fulfill a single customer's order, for example, an urgent customer's order. Based on the number of received customers orders and the number of articles in each order, the picking unit 200 uses one or more handling elements 208 to take one or more reception containers 24 and place them onto the platform 206. The reception containers 24 may be located in a predetermined section of the picking area.

As shown in FIG. 8, the picking unit 200 may be moved along the rails 20 so as to position the picking unit 200 near a selected source container 22 with one or more articles required to fulfill a customer's order. The case drive 258 controls the movable traverse element 214 and the carriage 216 so as to position the carriage 216 above the selected source container 22.

As shown in FIG. 9, the carriage 218 is moved down so as to position the protection case 212 directly above the selected source container 22. The gate drive 260 opens the gate 220 to provide an opening at the bottom of the protection case 212 The vision system 264 locates a required article in the selected source container 22 and provides the controller 250 with the location information. Based on this information, the manipulator drive 262 moves the gripper 224 down through the opening into the selected source container 22. The suction cap on the gripper 224 is activated to take the required article from the source container.

As shown in FIG. 10, the manipulator drive 262 lifts the gripper 224 with the required article to a vertical level above the gate 220. A sensing element of the position control system 266 may track the position of the article being lifted by the manipulator 222. As soon as the article is lifted above the level of the gate 220, the position control system 266 may provide this information to the controller 250 which controls the gate drive 260 to close the gate 220 so as to completely close the opening at the bottom of the protection case 212. As a result, if during the picking operation, an article is lost by the gripper 224, the article will be prevented from falling outside of the protection case 212. After closing the gate 220, the case drive 258 moves the carriage 218 up.

Thereafter, as shown in FIG. 11, the traverse element 214 and carriage 216 are moved in the direction of the frame 202 so as to position the protection case 212 above a selected reception container 24. The sensing element of the position control system 266 tracks the position of the article being moved. If the sensing elements detects that the article is lost, the gripper 224 is controlled to pick up the article from the protection case 212.

As shown in FIG. 12, after the protection case 212 is positioned above the selected reception container 24, the case drive 258 moves the carriage 218 down until the case 212 is positioned directly above the reception container 24. Then, the gate drive 260 opens the gate 220 to provide an opening at the bottom of the protection case 212. The vision system 264 determines a desired position in the reception container 24 for placing the article. The manipulator drive 262 moves the gripper 224 in a horizontal direction to position it above the desired position, and then moves the gripper 224 down to place the article in the desired position in the reception container 24.

As illustrated in FIG. 13, in the same manner, the picking unit 200 may place articles into the other reception container 24 arranged on the platform 208. After one or more orders are formed in the reception containers 24, the picking unit 200 uses the handling elements 208 to move the reception containers 24 from the platform 208 to a selected position in the picking area.

As discussed above, the order picking system 10 can efficiently fulfill multiple customers' orders received in advance. However, while fulfilling multiple orders received in advance, the system 10 is able to quickly respond to urgent orders made by customers who request that their orders be fulfilled immediately. For example, if a new urgent order is received, the picking unit 200 may suspend picking operations for the current order, and may begin to pick the articles for the new order among the source containers available in the picking area. At the same time, the transportation unit 100 may deliver to the picking area the source containers with the articles for the new order which are not available in the picking area.

The foregoing description illustrates and describes aspects of the present invention. Additionally, the disclosure shows and describes only preferred embodiments, but as aforementioned, it is to be understood that the invention is capable of use in various other combinations, modifications, and environments and is capable of changes or modifications within the scope of the inventive concept as expressed herein, commensurate with the above teachings, and/or the skill or knowledge of the relevant art.

The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein.

What is claimed is:

1. An order picking system responsive to customers' orders for picking ordered goods, comprising:
a storage system for storing containers arranged in multiple rows at various horizontal levels with respect to ground, the containers including source containers with goods stored in the storage system and reception containers to be filled with the ordered goods,
at least one mobile picking unit movable in a horizontal direction along an upper level of the storage system, the picking unit being configured for taking ordered goods from the source containers arranged at the upper level and placing the ordered goods into the reception containers for delivery to the customers, and
at least one transportation unit movable along a lower level of the storage system arranged lower than the upper level, the transportation unit being configured for taking the containers from levels of the storage system lower than the upper level, and delivering the containers to the upper level.

2. The system of claim 1, wherein the storage system includes first and second storage sections, and the picking unit and the transportation unit are configured for moving in the horizontal direction in a passage between the first storage section and the second storage section so as to have access to the containers arranged in both the first and the second storage sections.

3. The system of claim 2, wherein the picking unit and the transportation unit are respectively configured to move along upper and lower rails arranged corresponding to the upper and lower levels, respectively.

4. The system of claim 3, wherein the transportation unit includes a frame movable along the lower rails and a movable platform configured to move down with respect to the frame to take a container arranged at levels below a level corresponding to the lower rails.

5. The system of claim 4, wherein the movable platform is further configured to move up with respect to the frame after taking the container so as to carry the taken container to the upper level.

6. The system of claim 3, wherein the transportation unit includes a frame movable along the lower rails and a movable platform configured to move up with respect to the frame to take the containers arranged at levels above a level corresponding to the lower rails.

7. The system of claim 6, wherein the movable platform is further configured to move up with respect to the frame after taking the container so as to carry the taken container to the upper level.

8. The system of claim 3, wherein the picking unit includes a manipulator with an article holder for holding an article, a protection case with an opening in a bottom portion, and a gate controlled between an open state, in which the article holder is allowed to pass through the opening, and a close state, in which the opening is closed to prevent the article from falling from the protection case when the article is carried by the article holder from a source container to a reception container.

9. The system of claim 8, wherein the picking unit is configured for taking the reception container and carrying the reception container along the upper level when the picking unit moves from one source container to another source container.

10. The system of claim 1, wherein frequently ordered goods are stored in source containers arranged at the upper level.

11. A method of picking ordered goods in a storage system for storing containers arranged in multiple rows at various horizontal levels with respect to ground, using at least one mobile picking unit movable in a horizontal direction along an upper level of the storage system and at least one transportation unit movable along a lower level of the storage system arranged lower than the upper level, the method comprising the steps of:
controlling the transportation unit to take a first container from a level below the upper level and carry the first container to the upper level, and
controlling the picking unit to pick up an ordered article from the first container delivered by the transportation unit to the upper level, and place the article into a second container.

12. The method of claim 11, further comprising the step of controlling the transportation unit to take the second container and carry the second container to a level below the upper level for delivery to a customer.

13. The method of claim 11, further comprising the steps of:
controlling the transportation unit having a movable platform to move along the lower level to a selected position corresponding to a position of the first container at a first level below or above the lower level,
controlling the movable platform to move in a vertical direction to the first level to load the first container to the movable platform, and
controlling the movable platform to move in the vertical direction to the upper level to unload the first container at the upper level.

14. The method of claim 11, wherein the picking unit has a protection case and a gate configured to provide an opening in a bottom portion of the protection case when the gate is in an open state, and to close the opening when the gate is in a closed state, the method comprising the steps of:
placing the gate into the open state to take an article from the first container via the opening in the protection case using an article holder,
placing the gate into the closed state when the article holder raises the article above the bottom portion of the protection case,
moving the article holder with the article from a position above the first container to a position above the second container when the gate is in the closed state,
simultaneously with moving the article holder, moving the protection case from the position above the first container to the position above the second container so as to maintain the article above the bottom portion of the protection case, and
switching the gate into the open state to place the article to the second container via the opening in the protection case.

15. The method of claim 14, wherein the second container is carried by the picking unit.
